(19) United States
(12) Patent Application Publication
(10) Pub. No.: US 2020/0023438 A1
(43) Pub. Date: Jan. 23, 2020

(54) METHOD FOR PRODUCING A GAS TURBINE COMPONENT

(71) Applicant: Siemens Aktiengesellschaft, Munich (DE)

(72) Inventors: Bernd Burbaum, Falkensee (DE); Torsten Jokisch, Neuenhagen bei Berlin (DE)

(73) Assignee: Siemens Aktiengesellschaft, Munich (DE)

(21) Appl. No.: 16/465,785

(22) PCT Filed: Nov. 9, 2017
(86) PCT No.: PCT/EP2017/078720

§ 371 Date: May 31, 2019

(30) Foreign Application Priority Data
Dec. 8, 2016 (EP) 16202832.8

(51) Int. Cl. B22F 5/04; B22F 3/11; B22F 7/00; B23K 26/342; F01D 11/12

(52) U.S. Cl. CPC B22F 5/04; B22F 3/1125; B22F 2003/1056; B23K 26/342; F01D 11/122; B22F 7/006

(57) ABSTRACT

A method for producing a gas turbine component, which comes into frictional contact with a friction partner, includes: providing a base body produced from a superalloy; applying a first metal coating to a surface of the base body facing the at least one friction partner in the mounted state, wherein an additive production method using a first metal powder is used to apply the first metal coating; and applying a second metal coating to the first metal coating, wherein an additive production method using a second metal powder and a pulverulent pore-forming agent is used to apply the second metal coating and, by adding the pore-forming agent, the porosity of the second metal coating is set such that it is greater than the porosity of the first metal coating, and the volume flows of the introduced metal powder and the introduced pulverulent pore-forming agent are set or controlled separately.

### CROSS REFERENCE TO RELATED APPLICATIONS

This application is the U.S. National Stage of International Application No. PCT/EP2017/078720 filed Nov. 9, 2017, and claims the benefit thereof. The International Application claims the benefit of European Application No. EP16202832 filed Dec. 8, 2016. All of the applications are incorporated by reference herein in their entirety.

### FIELD OF INVENTION

The present invention relates to a method for producing a gas turbine component, which in the intended mounted state comes in frictional contact with at least one friction partner during the gas turbine operation.

### BACKGROUND OF INVENTION

In the prior art, it is already known that the efficiency of gas turbines can be increased by reducing the leakage losses. Correspondingly, efforts are made to minimize gaps between gas turbine components that move relative to one another. This applies in particular for the gaps between the guide ring segments on the stator side and the rotor blades on the rotor side, and the gaps between the guide vanes on the stator side and the rotor. One possible way of minimizing such gaps is to provide in particular the surfaces of the gas turbine components on the stator side, which in the intended mounted state come in frictional contact with at least one friction partner during operation of the gas turbine, with an abradable coating which is configured in such a way that it can be slightly abraded by the rotating friction partners in the event of contact. Such abradable coatings make it possible to reach rapidly a state of equilibrium between the components that move relative to one another, without excessive wear and while achieving a very small gap size.

### SUMMARY OF INVENTION

On the basis of this prior art, it is an object of the present invention to provide a method of the type mentioned in the introduction, with which a gas turbine component, which in the intended mounted state comes in frictional contact with at least one friction partner during the gas turbine operation, can be provided in a straightforward way with an abradable coating having deliberately adjusted properties.

In order to achieve this object, the present invention provides a method of the type mentioned in the introduction, which comprises the steps: providing a base body which is produced from a superalloy, in particular from a nickel-based alloy, applying a first metal coating onto a surface of the base body, which surface faces toward the at least one friction partner in the intended mounted state, an additive manufacturing method using a first metal powder being employed for the application; applying a second metal coating onto the first metal coating, an additive manufacturing method using a second metal powder and a pore-forming agent in powder form being employed for the application, and the porosity of the second metal coating being adjusted by the addition of the pore-forming agent in such a way that it is greater than the porosity of the first metal coating, and the volume flow rates of the supplied metal powder and the supplied pore-forming agent in powder form being adjusted or regulated separately.

The use of superalloys or nickel-based alloys for base bodies has proven useful in the past because of the good corrosion resistance and high-temperature stability of these materials. In the method according to the invention, a first metal coating and a second metal coating are successively applied onto such a base body, in each case by using an additive manufacturing method and corresponding metal powders, the porosity of the second metal coating being adjusted to be greater than the porosity of the first metal coating by using a pore-forming agent in powder form. The lower porosity of the first metal coating is advantageous insofar as the first metal coating has very good adhesion properties in relation to the base body. Associated with the higher porosity of the second metal coating is good abradability of the second metal coating, which is highly desirable in order to avoid leakage losses. By virtue of the fact that volume flow rates of the supplied metal powder and the supplied pore-forming agent in powder form are separately adjusted or regulated during the application of the second metal coating in the method according to the invention, the proportions of the two constituents can be varied continuously, so that any desired local variations of the pore formation are possible. Correspondingly, in particular the production of the second metal coating and therefore the properties of the second metal coating can be adapted in a straightforward way very flexibly to the desired requirements of the gas turbine component.

According to one configuration of the present invention, the metal coating is applied using only the first metal powder, so that this coating is essentially pore-free. In this way, an optimal adhesion effect and/or corrosion resistance are achieved.

Advantageously, the first metal coating is applied with a thickness which does not exceed 200 μm. With such a small thickness of the first metal coating, very good results have been achieved.

Advantageously, the volume flow rate of the pore-forming agent in powder form is adjusted or regulated during the application of the second metal coating in such a way that the porosity increases in the outward direction. In this way, a very good transition is achieved between the first metal coating and the second metal coating.

According to one configuration of the present invention, during the application of the second metal coating, protruding structures, in particular webs, which advantageously extend in the circumferential direction in relation to the mounting state more advantageously only in the circumferential direction, are formed on that outer surface which faces toward the at least one friction partner in the intended mounted state. As a result of such a structured outer surface of the second metal coating, the sealing between the gas turbine component and its at least one friction partner can be optimized, so that leakage losses during the gas turbine operation are reduced.

Advantageously, the first metal powder and the second metal powder are identical. Correspondingly, it is only necessary to provide a single metal powder for carrying out the method, so that the manufacturing is simplified and made more economical.

In particular, the first metal powder and the second metal powder are an MCrAlY powder, were M stands for the basic metal, which is in particular nickel and/or cobalt. The basic metal forms the basis of the adhesion layer and has, in particular, the purpose of providing the required toughness. Aluminum and chromium impart the required oxidation protection to the coating. Yttrium primarily reinforces the formation of stable oxides.

According to one configuration of the present invention, the first metal coating and the second metal coating are applied by means of laser-beam deposition welding. Laser-beam deposition welding is distinguished in particular by high achievable accuracies and by low heat input into the substrate.

Titanium dihydride powder, with which very good results have been achieved, in particular when MCrAlY is used as the metal powder for the second metal coating, is advantageously used as a pore-forming agent in powder form. The pore-forming agent evaporates at the melting temperature of the metal powder, so that the pores are then formed in the melt bath.

According to one configuration of the present invention, the gas turbine component is a guide ring segment and the at least one friction partner is a rotor blade, or vice versa. Very good results have been achieved in particular when producing guide ring segments by using the method according to the invention.

### BRIEF DESCRIPTION OF THE DRAWINGS

Further features and advantages of the present invention will become clear with the aid of the following description of a method according to one embodiment of the invention with reference to the drawing, in which:

FIG. 1 is a perspective view of a gas turbine component;

FIG. 2 is a schematic view, which shows by way of example a region of the gas turbine component represented in FIG. 1 during its production by using a method according to one embodiment of the present invention;

FIG. 3 is an enlarged view of the detail denoted in FIG. 2 with the reference III; and

FIG. 4 is a sectional view of a region of a gas turbine.

### DETAILED DESCRIPTION OF INVENTION

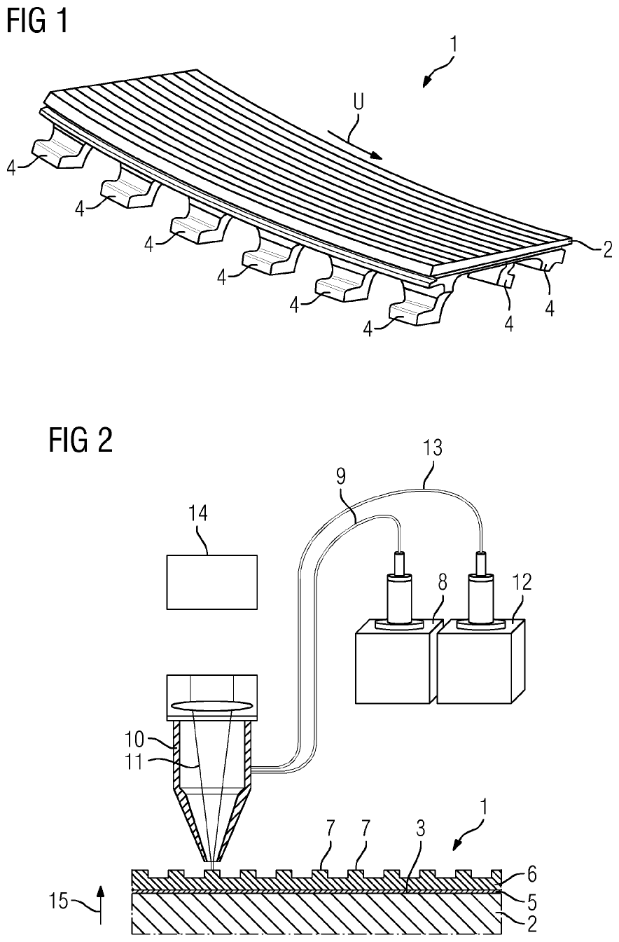

The gas turbine component 1 represented in FIGS. 1 to 3 is a so-called guide ring segment, the function of which will be explained in more detail below with reference to FIG. 4. The gas turbine component 1 in the present case comprises a base body 2, which is produced from a superalloy, for example a nickel-based alloy. The base body 2 defines on its front side an essentially rectangularly configured surface 3 provided with a constant curvature in a circumferential direction U. On the opposite rear side, the base body 2 defines a plurality of mounting projections 4, each with an approximately L-shaped cross section, which in the present case define three rows in the circumferential direction U, the mounting projections 4 of each row being configured essentially identically and aligned with one another. Provided at least on the surface 3 defined on the front side of the base body 2, there is a first metal coating 5 with a thickness d of advantageously not more than 200 μm, which in the present case is produced from MCrAlY, where M stands for the basic metal, which is nickel. As an alternative, cobalt could also be envisaged as a basic metal. Arranged on the first metal coating 5, there is a second metal coating 6 with a thickness D, which is 0.5-1 mm, a multiple of the thickness d of the first metal coating 5. The second metal coating 6 is in the present case likewise produced from MCrAlY, with nickel or alternatively cobalt as the basic metal. The structure of the second metal coating 6, however, differs from that of the first metal coating 5 insofar as the porosity is greater than that of the structure of the first metal coating 5. Formed on the outer side of the second metal coating 6, there are protruding structures 7, in the present case webs arranged next to one another, which extend parallel to one another in the circumferential direction U.

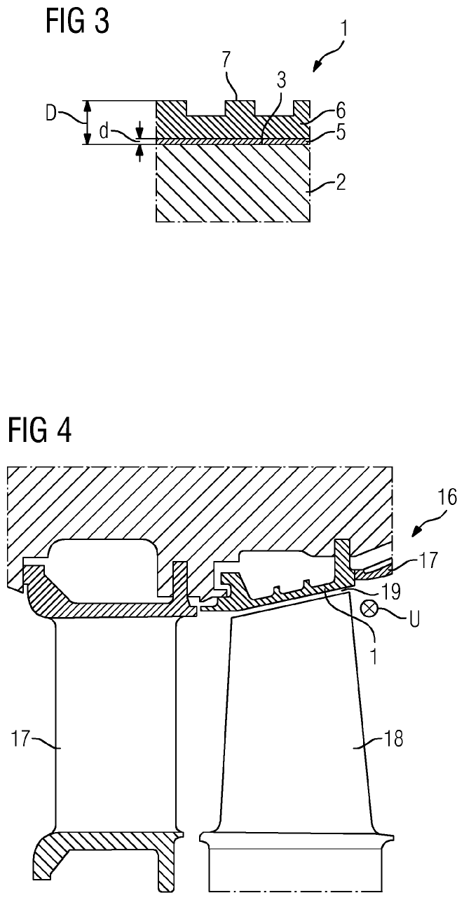

FIGS. 2 and 3 show the gas turbine component 1 during its production. In a first step, the base body 2 of the gas turbine component 1 is provided, for example as a cast body, to mention only one example. In a further step, the first metal coating 5 is applied onto the surface 3 of the base body 2. To this end, an additive manufacturing method is employed, using an MCrAlY powder which is stored in a first storage container 8. The additive manufacturing method is in the present case laser-beam deposition welding. Correspondingly, the MCrAlY powder is supplied through a first powder conveyor 9 to a welding nozzle 10, in which it is melted by a laser beam 11, the volume flow rate of the supplied powder being adjusted or regulated by means of a controller 14. The extensive application of the first metal coating 5 onto the surface 3 of the base body 2 is carried out, in a known manner, by guiding the welding nozzle 10 along corresponding paths over the surface 3.

In a further step, the second metal coating 6 is applied onto the first metal coating 5, likewise by means of laser-beam deposition welding. Simultaneously with the MCrAlY powder, during the generation of the second metal coating 6 a pore-forming agent in powder form, stored in a second storage container 12, is supplied to the welding nozzle 10 through a second powder conveyor 13, which pore-forming agent is melted and applied together with the metal powder. The effect of addition of the pore-forming agent, which in the present case is titanium dihydride powder, is that the resulting second metal coating 6 has a greater porosity than the first metal coating 5, which because of the exclusive use of the MCrAlY powder has a substantially pore-free structure. The volume flow rates of the supplied MCrAlY powder and of the supplied pore-forming agent in powder form are adjusted or regulated separately by means of a controller 14. Correspondingly, the porosity of the second metal coating 6 may be adjusted in any desired way, and therefore adapted to a very wide variety of requirements. The porosity of the second metal coating 6 may vary, in particular increase, from the inside out in the direction of the arrow 15, so that outer regions of the second metal coating can be abraded more easily than regions lying further inward. Likewise, however, the second metal coating 6 may have a constant porosity over its entire thickness D.

FIG. 4 shows by way of example a region of a gas turbine 16 in which gas turbine components 1 of the type coated according to FIGS. 1 to 3, which may differ from one another in relation to the shape of the base body 2 as a function of their position inside the gas turbine 16, are arranged on the stator side between guide vanes 17 of neighboring guide vane stages while forming a guide ring. Immediately radially adjacent to the gas turbine components 1, the free ends of rotor blades 18 mounted on the rotor side are arranged in such a way that only small annular gaps 19 remain between the gas turbine components 1, or guide ring segments, and the respective rotor blades 18. During operation of the gas turbine 16, because of thermal expansion, manufacturing and/or mounting inaccuracies or other external influences, for example centrifugal forces, the rotor blades 18 rub with their tips along the second metal coatings 6 of the gas turbine components 1, so that the second metal coatings 6 of the gas turbine components 1 are abraded slightly. This abrasion is promoted by the high porosity of the second metal coatings 6. Correspondingly, an annular gap 19 of optimal size is produced, which entails only small leakage losses. The structures 7 in the form of the circumferential webs, provided on the outer surface of the second metal coating 6, lead to further minimization of the leakage losses.

Although the invention has been illustrated and described in detail by the preferred exemplary embodiment, the invention is not restricted to the examples disclosed, and other variants may be derived therefrom by the person skilled in the art without departing from the protective scope of the invention. In particular, it should be pointed out that the gas turbine component 1 need not be a guide ring segment. Likewise, the gas turbine component 1 may also be a guide vane, a rotor blade or another component which moves relative to at least one friction partner during intended operation of the gas turbine and the outer surface of which is intended to be abraded at least partially by this partner.

1. A method for producing a gas turbine component, which in an intended mounted state comes in frictional contact with at least one friction partner during gas turbine operation, the method comprising:
providing a base body which is produced from a superalloy,
applying a first metal coating onto a surface of the base body, which surface faces toward the at least one friction partner in the intended mounted state, an additive manufacturing method using a first metal powder being employed for the application of the first metal coating;
applying a second metal coating onto the first metal coating, an additive manufacturing method using a second metal powder and a pore-forming agent in powder form being employed for the application of the second metal coating, and a porosity of the second metal coating being adjusted by the addition of the pore-forming agent in such a way that it is greater than the porosity of the first metal coating, and volume flow rates of the second metal powder and the pore-forming agent in powder form being adjusted or regulated separately.

2. The method as claimed in claim 1,
wherein the first metal coating is applied using only the first metal powder, so that this coating is essentially pore-free.

3. The method as claimed in claim 1,
wherein the first metal coating is applied with a thickness which does not exceed 200 μm.

4. The method as claimed in claim 1,
wherein the volume flow rate of the pore-forming agent in powder form is adjusted or regulated during the application of the second metal coating in such a way that the porosity increases in an outward direction.

5. The method as claimed in claim 1,
wherein during the application of the second metal coating, protruding structures are formed on that outer surface which faces toward the at least one friction partner in the intended mounted state.

6. The method as claimed in claim 1,
wherein the first metal powder and the second metal powder are identical.

7. The method as claimed in claim 1,
wherein the first metal powder and the second metal powder are an MCrAlY powder.

8. The method as claimed in claim 1,
wherein the first metal coating and the second metal coating are applied by laser-beam deposition welding.

9. The method as claimed in claim 1,
wherein titanium dihydride powder is used as a pore-forming agent in powder form.

10. The method as claimed in claim 1,
wherein the gas turbine component is a guide ring segment and the at least one friction partner is a rotor blade, or vice versa.

11. The method as claimed in claim 1,
wherein the superalloy comprises a nickel-based alloy.

12. The method as claimed in claim 5,
wherein the protruding structures comprise webs.

13. The method as claimed in claim 5,
wherein protruding structures comprise webs which extend in a circumferential direction in relation to the mounting state.

14. The method as claimed in claim 5,
wherein protruding structures comprise webs which extend only in a circumferential direction in relation to the mounting state.
